(19) United States
(12) Patent Application Publication
(10) Pub. No.: US 2012/0017070 A1
(43) Pub. Date: Jan. 19, 2012

(54) COMPILE SYSTEM, COMPILE METHOD, AND STORAGE MEDIUM STORING COMPILE PROGRAM

(76) Inventor: Satoshi Hieda, Tokyo (JP)

(21) Appl. No.: 13/254,327

(22) PCT Filed: Feb. 9, 2010
(86) PCT No.: PCT/JP10/00787

§ 371 Date: Sep. 1, 2011

(30) Foreign Application Priority Data
Mar. 25, 2009 (JP) 2009-073426

(51) Int. Cl. G06F 9/302

(52) U.S. Cl. 712/221; 712/E09.017

(57) ABSTRACT

To provide a compile system, a compile method, and a compile program capable of improving the execution speed of a program. A compile system according to the present invention includes a primary arithmetic unit 030, a plurality of optimization arithmetic units 130 to n30, and a plurality of shared storage devices 132 to n32, each of the plurality of shared storage devices being able to be accessed from the primary arithmetic unit 030 and being associated with one of the plurality of optimization arithmetic units 130 to n30. The optimization arithmetic unit n30 includes optimization means n31 for generating an optimized actual instruction sequence 331 from an IR instruction sequence 330 and storing the generated optimized actual instruction sequence into a shared storage device corresponding to the optimization arithmetic unit itself. The primary arithmetic unit 030 includes an optimization arithmetic unit selection means 032 for selecting an optimization arithmetic unit that generates the optimized actual instruction sequence 331 based on an access time from the primary arithmetic unit 030 to the shared storage devices, and instruction sequence execution means 031 for executing an actual instruction sequence including an optimized actual instruction sequence 331 stored in the shared storage device.

### TECHNICAL FIELD

The present invention relates to a compile system, a compile method, and a storage medium storing a compile program, in particular to a technique to optimize a program by using an arithmetic unit different from the arithmetic unit that executes an instruction sequence generated by performing JIT-compiling of the program.

### BACKGROUND ART

A JIT (Just In Time) compile system is a system that converts an IR (Intermediate Representation) instruction sequence into an actual instruction sequence executable by an arithmetic unit and then executes that actual instruction sequence. In such systems, it is desirable to optimize IR so that the program can be executed at a high speed and then to convert the optimized IR into actual instructions. However, there is a possibility that when the optimization and the JIT compiling of IR are executed by a single arithmetic unit, the execution speed of the program could be lowered. Therefore, it is desirable to execute the IR optimization process by using a different arithmetic unit from the arithmetic unit that converts the IR instruction sequence into an actual instruction sequence and executes the actual instruction sequence.

As examples of such JIT compile systems, Patent literatures 1 to 3 disclose JIT systems using multiple processors.

Patent literature 1 discloses a technique to improve the performance of program processing in a JIT compile system including a plurality of processors by executing each of a process for prefetching original instructions, a process for interpreting and executing the original instruction sequence, and a process for converting and optimizing the instruction sequence by using a different CPU (Central Processing Unit).

Further, in Patent literature 2, profile information about a program that is currently being executed by one CPU is collected and an instruction sequence is optimized during the execution based on that information by using another CPU. As described above, a technique to improve program execution efficiency by using different CPUs for the execution of an instruction sequence and for the optimization of the instruction sequence is disclosed.

Further, Patent literature 3 discloses a technique to increase a program execution speed by accurately estimating the degree of importance of a program block by combining a static analysis result and a dynamic analysis result by using a different core from the core for executing the program, and by carrying out pre-compiling based on this estimation.

However, the techniques disclosed in Patent literatures 1 to 3 cannot improve the execution speed of a program sufficiently when the optimized program code is executed. This is because these techniques give no consideration to the presence of the shared storage device that is shared by a plurality of arithmetic units like L2 cache in the multi-core CPU in the determination of the arithmetic unit that executes the optimization process.

Further, Patent literature 4 discloses a technique to rewrite a source program so that a block that enters a waiting state due to exclusive access control in parallel processing of the source program with another block, and thereby to reduce the waiting time caused by the exclusive access control when parallel processes access the same resource shared by the processes.

Further, Patent literature 5 discloses a technique to improve a process execution speed by scheduling a plurality of processes that are to be executed by the same execution processor and can access the same shared memory successively as much as possible and thereby by repeatedly using contents of the shared memory that are once stored in the cache of the processor without throwing out the contents.

### Citation List

### Patent Literature

Patent literature 1: Japanese Unexamined Patent Application Publication No. 2002-312180
Patent literature 3: Japanese Patent No. 4003830
Patent literature 3: Japanese Unexamined Patent Application Publication No. 2007-334643
Patent literature 4: Japanese Unexamined Patent Application Publication No. 9-138781
Patent literature 5: Japanese Unexamined Patent Application Publication No. 9-152976

### SUMMARY OF INVENTION

### Technical Problem

As explained above as background art, since no consideration has been given to the presence of the shared storage device that is shared by a plurality of arithmetic units in the JIR compiling, there is a problem that the execution speed of a program cannot be sufficiently improved.

To solve the above-described problem, an object of the present invention is to provide a compile system, a compile method, and a compile program capable of improving the execution speed of a program.

### Solution to Problem

A compile system according to the present invention is a compile system including: a primary arithmetic unit; a plurality of optimization arithmetic units; a plurality of shared storage devices, each the plurality of shared storage devices being able to be accessed from the primary arithmetic unit and being associated with one of the plurality of optimization arithmetic units, in which each of the optimization arithmetic units includes optimization means for generating an optimized actual instruction sequence from an IR instruction sequence and storing the generated optimized actual instruction sequence into a shared storage device corresponding to the optimization arithmetic unit itself, and the primary arithmetic unit includes: an optimization arithmetic unit selection means for selecting an optimization arithmetic unit that generates the optimized actual instruction sequence based on an access time from the primary arithmetic unit to the shared storage devices; and instruction sequence execution means for executing an actual instruction sequence including an optimized actual instruction sequence stored in the shared storage devices.

A compile method according to the present invention is a compile method to determine an optimization arithmetic unit that generates an optimized actual instruction sequence from among a plurality of optimization arithmetic units, the compile method including: an optimization determination step of determining whether or not the optimized actual instruction sequence is to be generated from an IR instruction sequence; and an optimization arithmetic unit selection step of, when the optimized actual instruction sequence is to be generated, selecting an optimization arithmetic unit that generates the optimized actual instruction sequence based on an access time from a primary arithmetic unit to a plurality of shared storage devices, each of the plurality of shared storage devices being able to be accessed from the primary arithmetic unit and being associated with one of the plurality of optimization arithmetic units.

A compile program according to the present invention is a compile program to determine an optimization arithmetic unit that generates an optimized actual instruction sequence from among a plurality of optimization arithmetic units, the compile program causing a computer to execute: an optimization determination step of determining whether or not the optimized actual instruction sequence is to be generated from an IR instruction sequence; and an optimization arithmetic unit selection step of, when the optimized actual instruction sequence is to be generated, selecting an optimization arithmetic unit that generates the optimized actual instruction sequence based on an access time from a primary arithmetic unit to a plurality of shared storage devices, each of the plurality of shared storage devices being able to be accessed from the primary arithmetic unit and being associated with one of the plurality of optimization arithmetic units.

### ADVANTAGEOUS EFFECTS OF INVENTION

According to the present invention, it is possible to provide a compile system, a compile method, and a compile program capable of improving the execution speed of a program.

### BRIEF DESCRIPTION OF DRAWINGS

FIG. 1 is a block diagram showing a general configuration of a JIT compile system according to a first exemplary embodiment of the present invention;

FIG. 2 is a block diagram showing a configuration of a JIT compile system according to a first exemplary embodiment of the present invention;

FIG. 3 is a flowchart showing an operation of a JIT compile system according to a first exemplary embodiment of the present invention;

FIG. 4 is a flowchart showing a detailed operation of JIT compile means according to a first exemplary embodiment of the present invention;

FIG. 5 is a block diagram showing a configuration of a JIT compile system according to a second exemplary embodiment of the present invention;

FIG. 6 is a flowchart showing an operation of a JIT compile system according to a second exemplary embodiment of the present invention;

FIG. 7 is a flowchart showing a detailed operation of JIT compile means according to a second exemplary embodiment of the present invention;

FIG. 8 is a block diagram showing a configuration of a JIT compile system according to a third exemplary embodiment of the present invention;

FIG. 9 is a flowchart showing an operation of a JIT compile system according to a third exemplary embodiment of the present invention;

FIG. 10 is a block diagram showing a configuration of a JIT compile system according to a first exemplary embodiment of the present invention;

FIG. 11A is a table showing instruction sequence execution information of a JIT compile system according to a first exemplary embodiment of the present invention;

FIG. 11B is a table showing a CPU usage rate of a JIT compile system according to a first exemplary embodiment of the present invention;

FIG. 11C is a table showing an access time to a storage device of a JIT compile system according to a first exemplary embodiment of the present invention;

FIG. 12 is a block diagram showing a configuration of a JIT compile system according to a second exemplary embodiment of the present invention;

FIG. 13A is a table showing instruction sequence execution information of a JIT compile system according to a second exemplary embodiment of the present invention;

FIG. 13B is a table showing a CPU usage rate of a JIT compile system according to a second exemplary embodiment of the present invention;

FIG. 13C is a table showing an access time to a storage device of a JIT compile system according to a second exemplary embodiment of the present invention;

FIG. 13D is a table showing optimization arithmetic unit information of a JIT compile system according to a second exemplary embodiment of the present invention;

FIG. 14 is a block diagram showing a configuration of a JIT compile system according to a third exemplary embodiment of the present invention;

FIG. 15A is a table showing instruction sequence execution information of a JIT compile system according to a third exemplary embodiment of the present invention;

FIG. 15B is a table showing a CPU usage rate of a JIT compile system according to a third exemplary embodiment of the present invention; and

FIG. 15C is a table showing an access time to a storage device of a JIT compile system according to a third exemplary embodiment of the present invention.

### DESCRIPTION OF EMBODIMENTS

### First Exemplary Embodiment

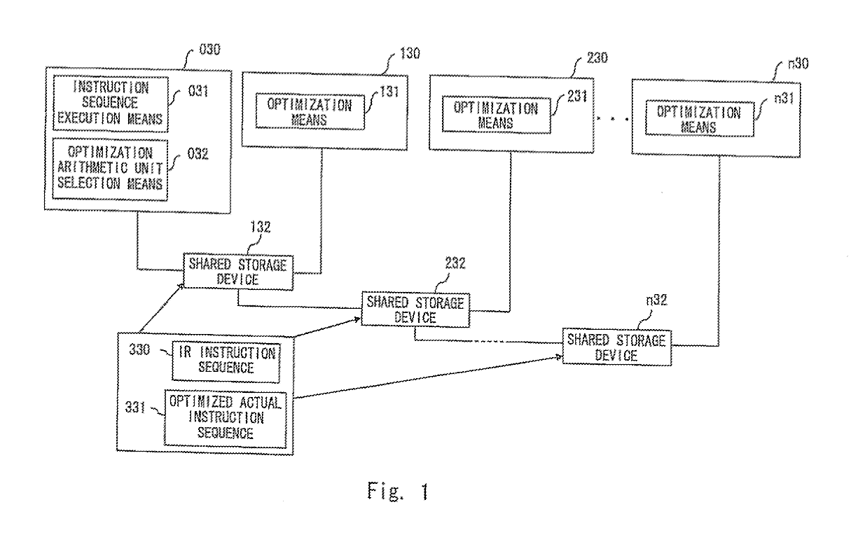

Firstly, an outline of a JIT-compile system according to a first exemplary embodiment of the present invention is explained with reference to FIG. 1. FIG. 1 is a block diagram showing a general configuration of a JIT compile system according to the first exemplary embodiment of the present invention.

The JIT-compile system includes a primary arithmetic unit 030 optimization arithmetic units 130 to n30, and shared storage devices 132 to n32.

The primary arithmetic unit 030 includes instruction sequence execution means 031 and optimization arithmetic unit selection means 032.

The optimization arithmetic units 130 to n30 include optimization means 131 to n31.

Note that “n” is a positive integer equal to or greater than 1.

When an optimized actual instruction sequence 331 that is executable by an arithmetic unit and is optimized is generated from an IR instruction sequence 330, the optimization arithmetic unit selection means 031 of the primary arithmetic unit 030 selects an optimization arithmetic unit that actually generates the optimized actual instruction sequence.

The instruction sequence execution means 032 of the primary arithmetic unit 030 executes an actual instruction sequence including an optimized actual instruction sequence that is generated by the optimization arithmetic units 130 to n30 and stored in the shared storage devices 132 to n32.

The optimization means 131 to n31 of the optimization arithmetic units 130 to n30 generate an optimized actual instruction sequence 331 from an IR instruction sequence 330 and store the generated optimized actual instruction sequence in shared storage devises corresponding to the optimization arithmetic units themselves. Note that the shared storage device n32 corresponds to the optimization arithmetic unit n30.

The shared storage devices 132 to n32 store an IR instruction sequence 330 and an optimized actual instruction sequence 331. The shared storage device n32 is a storage device that can be accessed from the optimization arithmetic unit n32 and also can be accessed from the primary arithmetic unit 030.

Next, an outline of an operation of the JIT-compile system according to the first exemplary embodiment of the present invention is explained with reference to FIG. 1.

Firstly, when an optimized actual instruction sequence 331 is generated from an IR instruction sequence 330, the optimization arithmetic unit selection means 032 of the primary arithmetic unit 030 selects an optimization arithmetic unit that actually generates the optimized actual instruction sequence 331.

Next, the optimization means 131 to n31 of the optimization arithmetic unit 130 to n30 selected by the primary arithmetic unit 030 generates the optimized actual instruction sequence 331 from the IR instruction sequence 330 and stores the generated optimized actual instruction sequence into a shared storage device corresponding to the optimization arithmetic unit itself.

Then, the instruction sequence execution means 031 of the primary arithmetic unit 030 executes the optimized actual instruction sequence, which was generated by the optimization arithmetic unit 130 to n30 and stored in the shared storage device 132 to n32.

Next, the JIT-compile system according to the first exemplary embodiment of the present invention is explained in a more detailed manner with reference to the drawings.

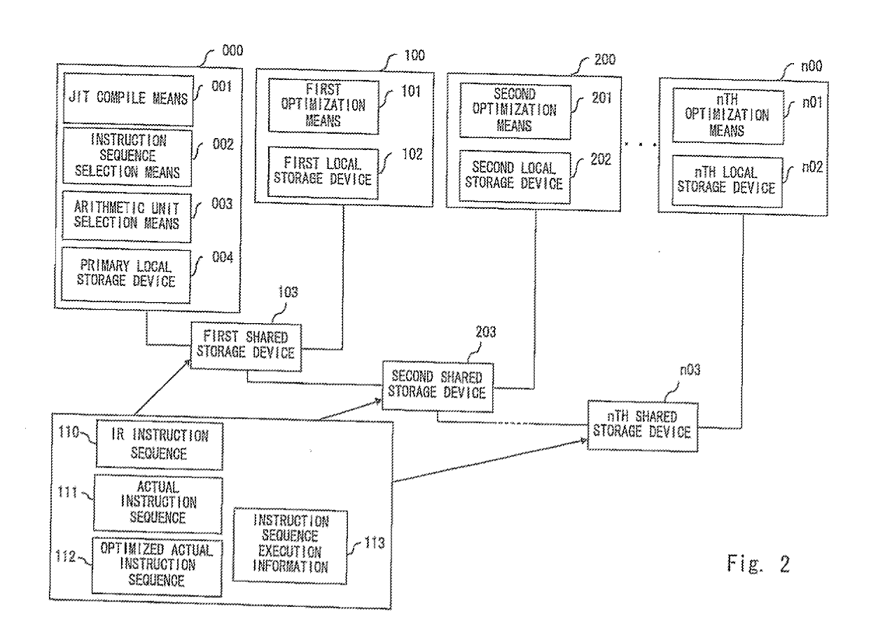

Referring to FIG. 2, the JIT-compile system according to the first exemplary embodiment of the present invention includes a primary arithmetic unit 000, first to nth arithmetic units 100 to n00, and first to nth shared storage devices 103 to n03. Note that “n” is a positive integer equal to or greater than 1.

The first to nth shared storage devices 103 to n03 are storage devices that store data used by the primary arithmetic unit 000 and the first to nth arithmetic units 100 to n00. Further, each of the shared storage devices is shared by a plurality of arithmetic units. For example, the first shared storage device 103 is a storage device that stores data shared by the primary arithmetic unit 000 and the first arithmetic unit 100, while the second shared storage device 203 is a storage device that stores data shared by the primary arithmetic unit 000 and the first and second arithmetic units 100 and 200.

Further, the first to nth shared storage devices 103 to n03 form a storage hierarchy. When the primary arithmetic unit 000 accesses a kth shared storage device (1≦k≦n), the access time is increased with the increase of the value of k of the shared data area. Further, data stored in these shared storage devices is not continuously stored in the particular shared storage devices. That is, data may be copied from one shared storage device to another under instructions from the arithmetic units. However, the consistency of data is ensured among these shared storage devices even when new data is written.

In the first to nth shared storage devices 103 to n03, an IR instruction sequence(s) 110, an actual instruction sequence(s) 111, an optimized actual instruction sequence(s) 112, and instruction sequence execution information 113 are stored.

The IR instruction sequence 110 is an instruction sequence that expresses a programmed operation(s) by using pseudo-code that cannot be directly executed by an arithmetic unit. A program is divided into a plurality of IR instruction sequences 110 and stored in a shared storage device(s). The IR instruction sequence 110 is an instruction sequence expressed by intermediate code such as byte-code according to JAVA (registered trademark) and CLI (Common Intermediate Language) according to .NET Framework (registered trademark).

The actual instruction sequence 111 is an instruction sequence that is obtained by converting an IR instruction sequence 110 into an instruction format that can be directly executed by an arithmetic unit.

The optimized actual instruction sequence 112 is an instruction sequence that is obtained by performing an optimization process of an IR instruction sequence 110 and then converting into an instruction format that can be directly executed by an arithmetic unit. Since the optimization process is performed, the optimized actual instruction sequence 112 can-be executed in a shorter time than the actual instruction sequence 111.

The instruction sequence execution information 113 contains profile information about the execution of an IR instruction sequence 110 stored in the shared storage devices 103 to n03, information indicating which actual instruction sequence 111 or optimized actual instruction sequence 112 generated from an IR instruction sequence 110 is associated with the original IR instruction sequence, and the like.

The primary arithmetic unit 000 is an arithmetic unit used to perform JIT-compiling of a program, and includes therein JIT-compile means 001, instruction sequence selection means 002, arithmetic unit selection means 003, and a primary local storage device 004.

The JIT-compile means 001 determines whether or not there is any optimized actual instruction sequence 112 associated with an IR instruction sequence 110 that is about to be executed by referring to the instruction sequence execution information 113. When an optimized actual instruction sequence 112 is associated with the IR instruction sequence 110, that optimized actual instruction sequence 112 is executed. When no optimized actual instruction sequence 112 is associated with the IR instruction sequence 110, then the JIT-compile means 001 determines whether or not there is any actual instruction sequence 111 associated with the IR instruction sequence 110. When an actual instruction sequence 111 is associated with the IR instruction sequence 110, that actual instruction sequence 111 is executed. When no actual instruction sequence 111 is associated with the IR instruction sequence 110, the IR instruction sequence 110 is converted into an actual instruction sequence 111 and then the converted actual instruction sequence 111 is executed. Further, the association between the IR instruction sequence 110 and the actual instruction sequence 111 is written into the instruction sequence execution information 113. The JIR compile means functions as instruction sequence execution means.

The instruction sequence selection means 002 selects an IR instruction sequence 110 relating to the IR instruction sequence 110 that is currently being executed as an IR instruction sequence to be optimized. The “IR instruction sequence 110 relating to the IR instruction sequence 110” is an IR instruction sequence 110 that will be probably executed in conjunction with the currently-executed IR instruction sequence 110. Examples of the IR instruction sequence 110 relating to the currently-executed IR instruction sequence 110 include the currently-executed IR instruction sequence 110 itself, an IR instruction sequence 110 at a branch destination of the currently-executed IR instruction sequence 110, and a group of IR instruction sequences including the currently-executed IR instruction sequence 110 and an IR instruction sequence 110 at the branch destination. In the following explanation, the IR instruction sequence 110 relating to the currently-executed IR instruction sequence 110 is referred to as “relevant IR instruction sequence”.

The arithmetic unit selection means 003 first selects an arithmetic unit that actually executes an optimization process. In this process, the arithmetic unit selection means 003 selects the arithmetic unit by referring to the usage rate of each candidate arithmetic unit 100 to n00, the access time to a shared storage device that is shared between each arithmetic unit 100 to n00 and the primary arithmetic unit 000, and/or the like. Note that the usage rate of each arithmetic unit 100 to n00 is dynamically obtained from each arithmetic unit 100 to n00. Further, the access time to the shared storage device 103 to n03 is obtained as a static value in advance by carrying out access from the primary arithmetic unit 000 to each shared storage device 103 to n03. Note that the usage rate of each arithmetic unit 100 to n00 and the access time to the shared storage device 103 to n03 are made available for reference by, for example, storing information indicating these values in the shared storage devices 103 to n03 in advance. Further, the arithmetic unit selection means 003 instructs the selected arithmetic unit to optimize the selected IR instruction sequence 110. The arithmetic unit selection means functions as optimization arithmetic unit selection means.

The primary local storage device 004 is a storage device that stores data used when the primary arithmetic unit 000 performs processing. The primary local storage device is, for example, a cache memory of the primary arithmetic unit.

Each of the first to nth arithmetic units 100 to n00 is an arithmetic unit that is used to execute the optimization process of an IR instruction sequence 110. The first to nth arithmetic units 100 to n00 includes first to nth optimization means 101 to n01 and first to nth local storage devices 102 to n02.

The first to nth optimization means 101 to n01 first performs optimization of an indicated IR instruction sequence 110 so that the IR instruction sequence 110 can be executed at a higher speed on the system, and thereby converts the optimized IR instruction sequence 110 into an optimized actual instruction sequence 112. Further, the first to nth optimization means 101 to n01 write the association between the indicated IR instruction sequence 110 and the optimized actual instruction sequence 112 into the instruction sequence execution information 113.

Each of the first to nth local storage devices 102 to n02 is a storage device that stores data used when a respective arithmetic unit performs processing. The nth local storage device is, for example, a cache memory of the nth arithmetic unit.

Note that some of the primary arithmetic unit 000 and first to nth arithmetic units 100 to n00 may be integrated into one CPU package as a multi-core CPU. For example, the primary arithmetic unit 000 and first to third arithmetic units may be integrated into one CPU package as a multi-core CPU.

Further, in conjunction with this, when a plurality of arithmetic units are integrated as a multi-core CPU, the shared storage devices associated with these integrated arithmetic units may be also integrated into one shared storage device. For example, when the primary arithmetic unit 000 and first to third arithmetic units are integrated as a multi-core CPU, the first to third shared storage devices 103 to 303 may be also integrated into one shared storage device that can be shared by the primary arithmetic unit 000 and first to third arithmetic units 100 to 300.

Further, all of the primary arithmetic unit and the first to nth arithmetic units 000 may be located in a plurality of different nodes and connected through a network.

Further, although the primary arithmetic unit 000 does not have any optimization means in the configuration according to this exemplary embodiment, the primary arithmetic unit 000 may have primary optimization means and the arithmetic unit selection means 003 may select the arithmetic unit that executes the optimization process from among the primary arithmetic unit 000 and first to nth arithmetic units 100 to n00.

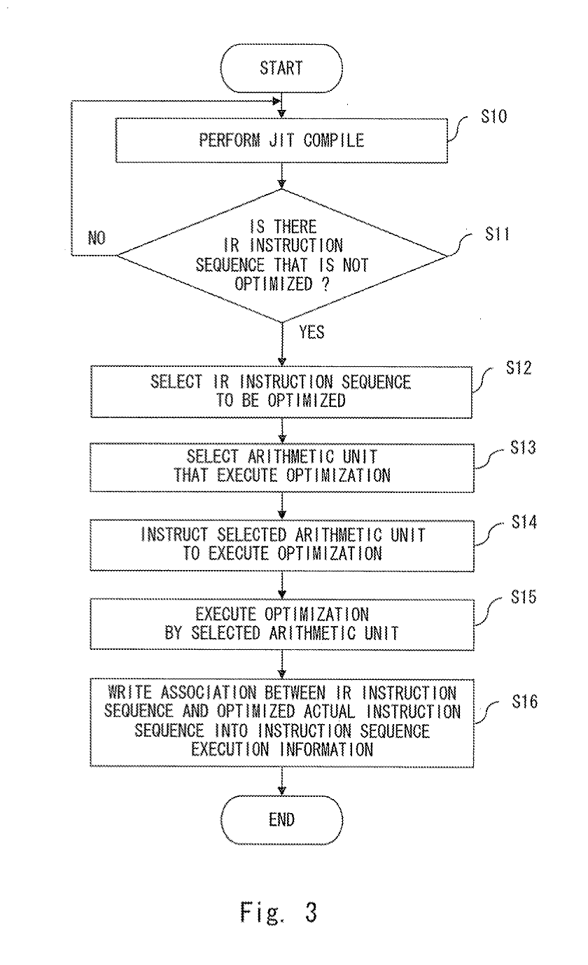

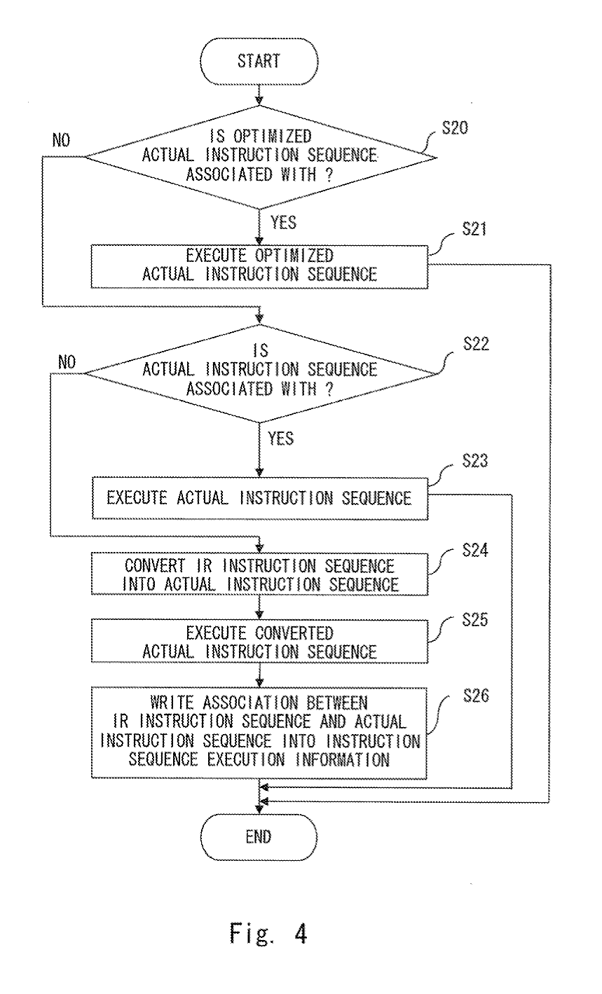

Next, an overall operation of this exemplary embodiment is explained in-detail with reference to FIG. 2 and flowcharts shown in FIGS. 3 and 4.

Firstly, in the primary arithmetic unit 000, the JIT-compile means 001 executes an IR instruction sequence 110 (step S10 in FIG. 3).

Details of this step S10 are explained hereinafter. Firstly, the JIT-compile means 001 checks whether or not there is any optimized actual instruction sequence 112 associated with the IR instruction sequence 110 that is about to be executed by referring to the instruction sequence execution information 113 (step S20 in FIG. 4).

When an optimized actual instruction sequence 112 is associated with the IR instruction sequence 110, the JIT-compile means 001 executes that optimized actual instruction sequence 112 (step S21).

When no optimized actual instruction sequence 112 is associated with the IR instruction sequence 110, the JIT-compile means 001 checks whether or not there is any actual instruction sequence 111 associated with the IR instruction sequence 110 (step S22).

When an actual instruction sequence 111 is associated with the IR instruction sequence 110, the JIT-compile means 001 executes that actual instruction sequence 111 (step S23).

When no actual instruction sequence 111 is associated with the IR instruction sequence 110, the JIT-compile means 001 converts the IR instruction sequence 110 into an actual instruction sequence 111 (step S24), and then executes the converted actual instruction sequence 111 (step S25). Further, the JIT-compile means 001 writes the association between the IR instruction sequence 110 and the actual instruction sequence 111 into the instruction sequence execution information 113 (step S26).

When the step S10 of FIG. 3 is carried out, the instruction sequence selection means 002 determines whether or not there is any IR instruction sequence for which the optimization process has not been performed yet among the relevant IR instruction sequences 110 of the IR instruction sequence 110 that is to be executed by the JIT-compile means 001 by referring to the instruction sequence execution information 113 (step S11 in FIG. 3).

When there is a relevant IR instruction sequence(s) 110 for which the optimization process has not been performed yet, the instruction sequence selection means 002 selects an arbitrary IR instruction sequence from the relevant IR instruction sequences 110 as an IR instruction sequence to be optimized (step S12). Note that, for example, an IR instruction sequence 110 that has been executed more times than any other IR instruction sequences may be selected from the relevant IR instruction sequences 110. In this way, the possibility that the optimized actual instruction sequence is executed becomes higher, thereby improving the execution speed of the program even further. When there is no relevant IR instruction sequence 110 for which the optimization process has not been performed yet, the process returns to the step S10.

Next, the arithmetic unit selection means 003 selects an arithmetic unit that actually executes the optimization process of the block to be optimized (step S13). In this process, the arithmetic unit selection means 003 selects the arithmetic unit that executes the optimization process by referring to the usage rate of each candidate arithmetic unit 100 to n00, the access time to a shared storage device that is shared between each arithmetic unit 100 to n00 and the primary arithmetic unit 000, and/or the like. Specifically, an arithmetic unit that corresponds to a shared storage device having a shorter access time and has a lower usage rate is preferentially selected. Note that a shared storage device for which the access time from the primary arithmetic unit 000 is the shortest, among the shared storage devices that are shared between the primary arithmetic unit 000 and an arbitrary one of the arithmetic units 100 to n00, becomes the shared storage device corresponding to this arbitrary arithmetic unit. Note that the present invention is not limited to the configuration of the first exemplary embodiment, and a configuration in which a plurality of arithmetic units correspond to one shared storage device may be also employed.

Next, the arithmetic unit selection means 003 instructs the selected arithmetic unit to optimize the selected IR instruction sequence 110 (step S14).

In accordance with this instruction, the optimization means of the selected arithmetic unit executes the optimization process of the indicated IR instruction sequence 110, and thereby converts into an optimized actual instruction sequence 112 (step S15). Further, the optimization means writes the association between the IR instruction sequence 110 and the optimized actual instruction sequence 112 into the instruction sequence execution information 113 (step S16).

After these processes, when the JIT-compile means 001 is about to execute a selected IR instruction sequence 110, it refers to the instruction sequence execution information 113 and thereby executes the optimized actual instruction sequence 112 associated with the IR instruction sequence 110 to be executed. This process corresponds to the step S21 in FIG. 4.

Next, advantageous effects of this exemplary embodiment are explained.

This exemplary embodiment is configured in such a manner that the arithmetic unit selection means 003 preferentially instructs an arithmetic unit that shares a shared storage device having a higher access speed to execute an optimization process. As a result, in comparison to cases where the configuration like this is not adopted, the possibility that an optimized actual instruction sequence 112 is stored in a shared storage device that can be accessed at a higher speed becomes higher, and thereby improving the execution speed of the program when the primary arithmetic unit 000 executes the optimized actual instruction sequence 112.

Further, this exemplary embodiment is configured in such a manner that an arithmetic unit having a lower usage rate is preferentially instructed to execute an optimization process. As a result, in comparison to cases where the configuration like this is not adopted, an optimization process can be executed more quickly. Consequently, the optimized actual instruction sequence 112 is made available to the primary arithmetic unit 000 more quickly, and thereby improving the execution speed of the program.

### Second Exemplary Embodiment

Next, a JIT-compile system according to a second exemplary embodiment of the present invention is explained in detail with reference to the drawings.

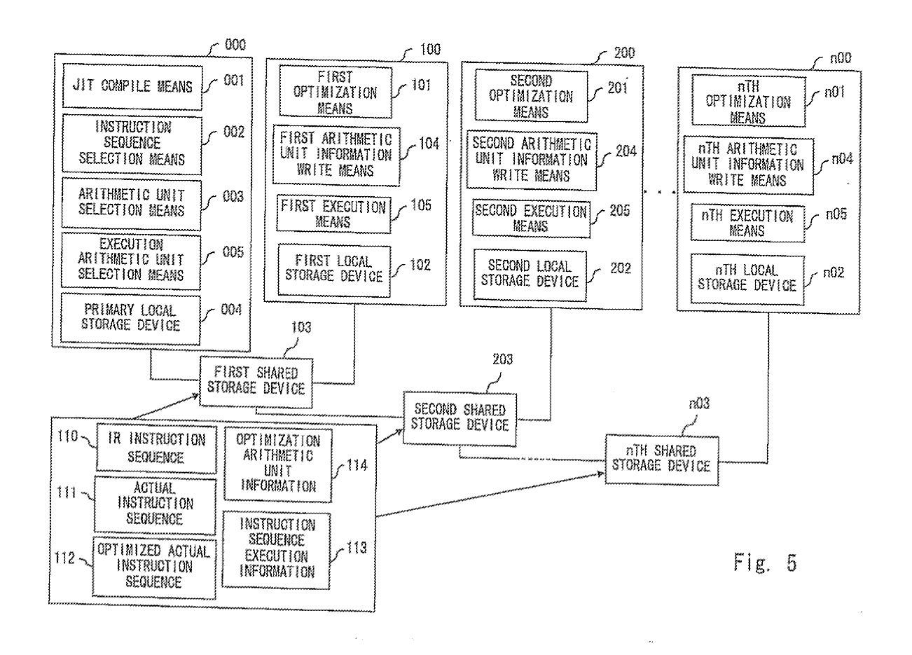

Referring to FIG. 5, a JIT-compile system according to the second exemplary embodiment of the present invention is different from that of the first exemplary embodiment in that: the primary arithmetic unit 000 includes execution arithmetic unit selection means 005; an nth arithmetic unit includes nth arithmetic unit information write means n04 and nth execution means n05; and the shared storage device includes optimization arithmetic unit information 114. Note that the remaining configuration is the same as that of the first exemplary embodiment.

The optimization arithmetic unit information 114 contains information about which arithmetic unit the IR instruction sequence 110 has been optimized by.

The execution arithmetic unit selection means 005 selects the arithmetic unit that has optimized the IR instruction sequence 110 by referring to the optimization arithmetic unit information 114. Next, the execution arithmetic unit selection means 005 instructs the selected arithmetic unit to execute an optimized actual instruction sequence 112 associated with the IR instruction sequence 100.

The first to nth arithmetic unit information write means 104 to n04 write the association between an IR instruction sequence 110 and their own arithmetic unit identifier into the optimization arithmetic unit information 114.

The first to nth execution means 105 to n05 execute a specified optimized actual instruction sequence 112 on behalf of the JIT-compile means 001.

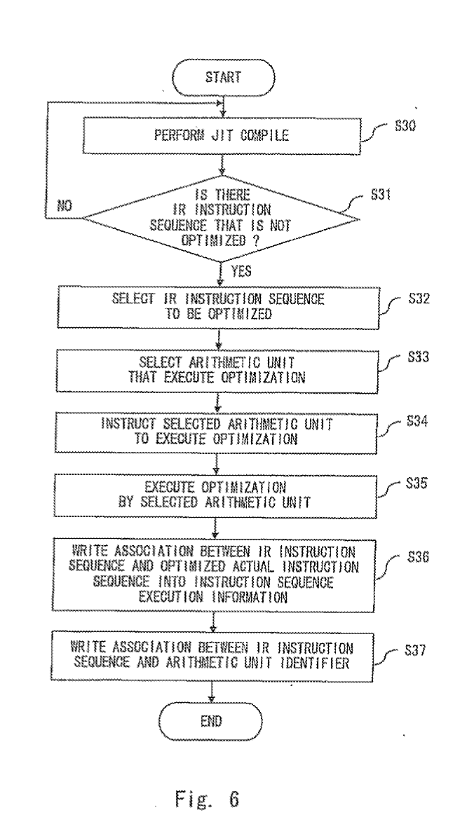

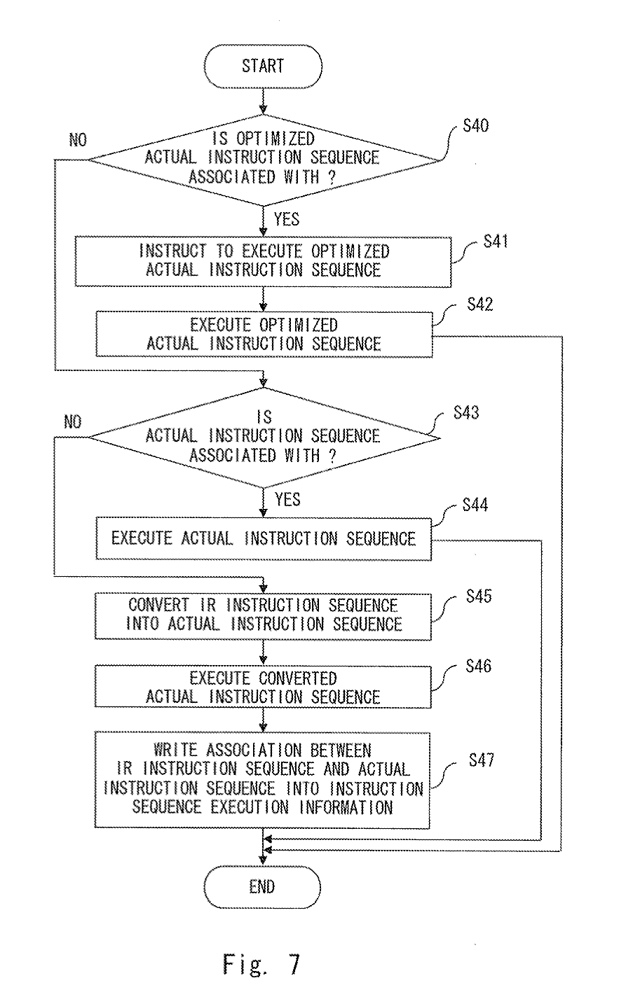

Next, an overall operation of this exemplary embodiment is explained in detail with reference to FIG. 5 and flowcharts shown in FIGS. 6 and 7.

Firstly, in the primary arithmetic unit 000, the JIT-compile means 001 executes an IR instruction sequence (step S30 in FIG. 6).

Details of this step S30 are explained hereinafter. Firstly, the JIT-compile means 001 checks whether or not there is any optimized actual instruction sequence 112 associated with an IR instruction sequence 110 that is about to be executed by referring to the instruction sequence execution information 113 (step S40 in FIG. 7).

When an optimized actual instruction sequence 112 is associated with the IR instruction sequence 110, the execution arithmetic unit selection means 005 further refers to the optimization arithmetic unit information 114 and thereby instructs the arithmetic unit that has optimized the IR instruction sequence 110 to execute the optimized actual instruction sequence 112 (step S41). In accordance with this instruction, the execution-means of the instructed arithmetic unit executes the indicated optimized actual instruction sequence 112 (step S42).

When no optimized actual instruction sequence 112 is associated with the IR instruction sequence 110 in the step S40, the JIT-compile means 001 checks whether or not there is any actual instruction sequence 111 associated with the IR instruction sequence 110 (step S43).

When an actual instruction sequence 111 is associated with the IR instruction sequence 110, the JIT-compile means 001 executes that actual instruction sequence 111 (step S44).

When no actual instruction sequence 111 is associated with the IR instruction sequence 110, the JIT-compile means 001 converts the IR instruction sequence 110 into an actual instruction sequence 111 (step S45), and then executes the converted actual instruction sequence 111 (step S46). Further, the JIT-compile means 001 writes the association between the IR instruction sequence 110 and the actual instruction sequence 111 into the instruction sequence execution information 113 (step S47).

The operations from the step S31 to the step S36 in FIG. 6 are the same as those in the step S11 to the step S16 in the first exemplary embodiment, and therefore their explanation is omitted.

Further, after the operation in the step S36, the arithmetic unit information write means of the selected arithmetic unit writes the association between the IR instruction sequence 110 and its own arithmetic unit identifier into the optimization arithmetic unit information 114 in this exemplary embodiment (step S37 in FIG. 6).

Next, advantageous effects of this exemplary embodiment are explained.

This exemplary embodiment is configured in such a manner that an arithmetic unit that has performed an optimization process executes the optimized actual instruction sequence 112. As a result, the possibility that the arithmetic unit that has performed the optimization process executes the optimized actual instruction sequence 112 stored in a local storage device, which can be accessed at a higher speed than the shared storage devices, becomes higher. Therefore, the execution speed of the program is improved even further compared to the first exemplary embodiment of the present invention.

### Third Exemplary Embodiment

Next, a JIT-compile system according to a third exemplary embodiment of the present invention is explained in detail with reference to the drawings.

Referring to FIG. 8, a JIT-compile system according to the third exemplary embodiment of the present invention is different from that of the first exemplary embodiment in that the primary arithmetic unit 000 does not include the instruction sequence selection means 002 and the arithmetic unit selection means 003, but does include instruction sequence multiple selection means 006 and arithmetic unit multiple selection means 007. Note that the remaining configuration is the same as that of the first exemplary embodiment.

The instruction sequence multiple selection means 006 selects at least one IR instruction sequence 110 relating to the IR instruction sequence 110 that is currently being executed as an IR instruction sequence to be optimized. The “IR instruction sequence 110 relating to the IR instruction sequence 110” is an IR instruction sequence(s) 110 that will be probably executed in conjunction with the currently-executed IR instruction sequence 110. Examples of the IR instruction sequence 110 relating to the currently-executed IR instruction sequence 110 include the currently-executed IR instruction sequence 110 itself, an IR instruction sequence 110 at a branch destination of the currently-executed IR instruction sequence 110, and a group of IR instruction sequences including the currently-executed IR instruction sequence 110 and an IR instruction sequence 110 at the branch destination.

The arithmetic unit multiple selection means 007 selects the same number of arithmetic units that optimize the at least one IR instruction sequence 110 selected by the instruction sequence multiple selection means 006 as the number of the selected IR instruction sequences 110. In this process, the arithmetic unit multiple selection means 007 selects the arithmetic unit(s) by referring to the usage rate of each candidate arithmetic unit 100 to n00, the access time to a shared storage device that is shared between each arithmetic unit 100 to n00 and the primary arithmetic unit 000, and/or the like. Note that the usage rate of each arithmetic unit 100 to n00 is dynamically obtained from each arithmetic unit 100 to n00. Further, the access time to the shared storage device 103 to n03 is obtained as a static value in advance by carrying out access from the primary arithmetic unit 000 to each shared storage device 103 to n03. Further, the arithmetic unit multiple selection means 007 instructs the selected arithmetic unit(s) to optimize the selected IR instruction sequence(s) 110.

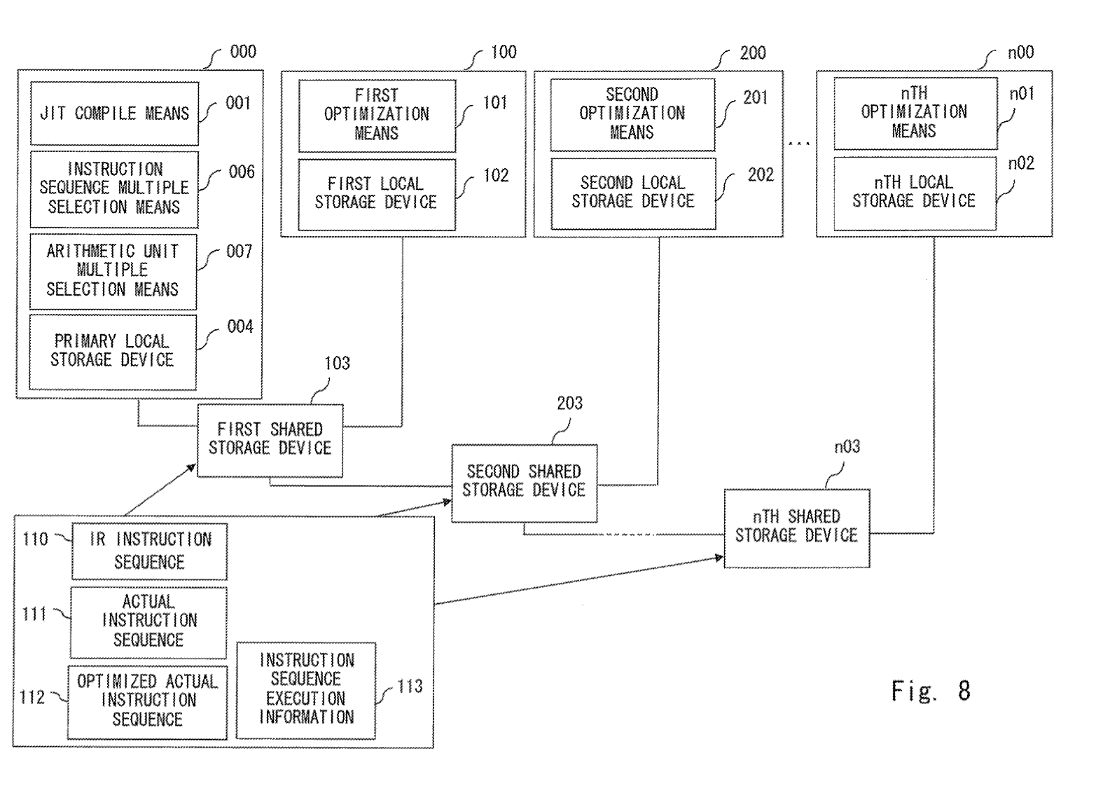

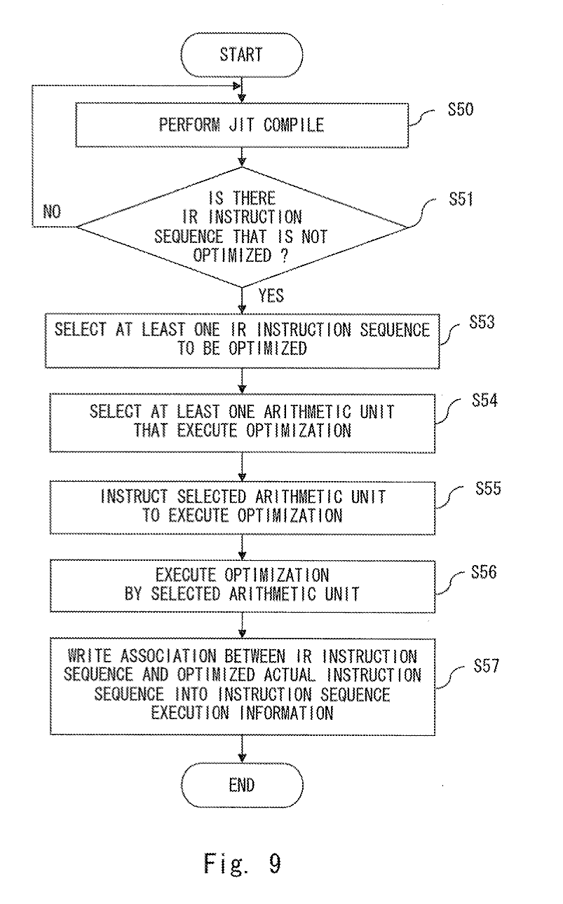

Next, an overall operation of this exemplary embodiment is explained in detail with reference to FIGS. 8 and 9.

Firstly, when the JIT-compile means 001 of the primary arithmetic unit 000 executes an IR instruction sequence 110 (step S50 in FIG. 9, which is the same as the step S10 in FIG. 3), the instruction sequence multiple selection means 006 determines whether or not there is any IR instruction sequence for which the optimization process has not been performed yet among the relevant IR instruction sequences 110 of the IR instruction sequence 110 that is to be executed by the JIT-compile means 001 by referring to the instruction sequence execution information 113 (step S51).

When there is a relevant IR instruction sequence 110 for which the optimization process has not been performed yet, the instruction sequence multiple selection means 006 selects at least one arbitrary IR instruction sequence from the relevant IR instruction sequences 110 as an IR instruction sequence(s) to be optimized (step S53). Note that, for example, at least one IR instruction sequence 110 may be selected from the relevant IR instruction sequences 110 in descending order of the number of executions of the IR instruction sequence 110. In this way, the possibility that an optimized actual instruction sequence is executed becomes higher, thereby improving the execution speed of the program even further.

When there is no relevant IR instruction sequence 110 for which the optimization process has not been performed yet, the process returns to the step S50.

Next, the arithmetic unit multiple selection means 007 selects a plurality of arithmetic units that are used to optimize the plurality of selected IR instruction sequences 110 (step S54). In this process, the arithmetic unit multiple selection means 007 selects the same number of arithmetic units that actually execute the optimization process as the number of the IR instruction sequences selected in the step S53 by referring to the usage rate of each candidate arithmetic unit 100 to n00, the access time to a shared storage device that is shared between each arithmetic unit 100 to n00 and the primary arithmetic unit 000, and/or the like. Specifically, arithmetic units that correspond to shared storage devices having a shorter access time are selected in ascending order of their usage rate.

Next, the arithmetic unit multiple selection means 007 instructs each of the selected arithmetic units to optimize a respective one of the selected IR instruction sequences 110 (step S55).

In accordance with this instruction, each of the selected arithmetic units carries out the optimization process of the indicated IR instruction sequence 110, and thereby converts into an optimized actual instruction sequence 112 (step S56). Further, the association between the IR instruction sequence 110 and the actual instruction sequence 111 is written into the instruction sequence execution information 113 (step S57).

After these processes, when the JIT-compile means 001 is about to execute a selected IR instruction sequence 110, it refers to the instruction sequence execution information 113 and thereby executes the optimized actual instruction sequence 112 associated with the IR instruction sequence 110 to be executed. This process corresponds to the step S21 in FIG. 4.

Next, advantageous effects of this exemplary embodiment are explained.

This exemplary embodiment is configured in such a manner that a plurality of JR instruction sequences 110 relating to the currently-executed IR instruction sequence 110 can be optimized simultaneously by the instruction sequence multiple selection means 006 and the arithmetic unit multiple selection means 007. As a result, the possibility that the optimized actual instruction sequence 112 can be referred at the time of JIT compiling becomes higher, and thereby improving the execution speed of the program even further compared to the first exemplary embodiment of the present invention.

Note that the present invention is not limited to the above-described exemplary embodiments, and various modifications can be made to them without departing from the spirit of the present invention. For example, when the arithmetic unit that provides an instruction about an optimization process is selected, an arithmetic unit(s) having a larger number of clocks, instead of or in addition to having a lower usage rate, may be preferentially selected so that the optimization process can he performed quickly.

Further, for example, when an optimized actual instruction sequence 112 is deleted from a local storage device, the association between the IR instruction sequence 110 corresponding to this optimized actual instruction sequence 112 and the arithmetic unit identifier of the arithmetic unit may be also deleted from the optimization arithmetic unit information 114.

### First Example

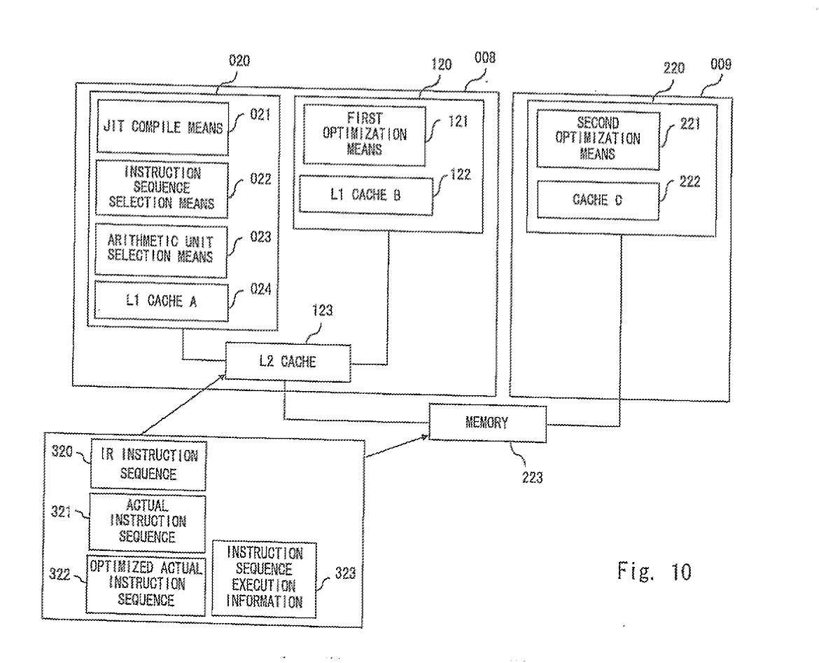

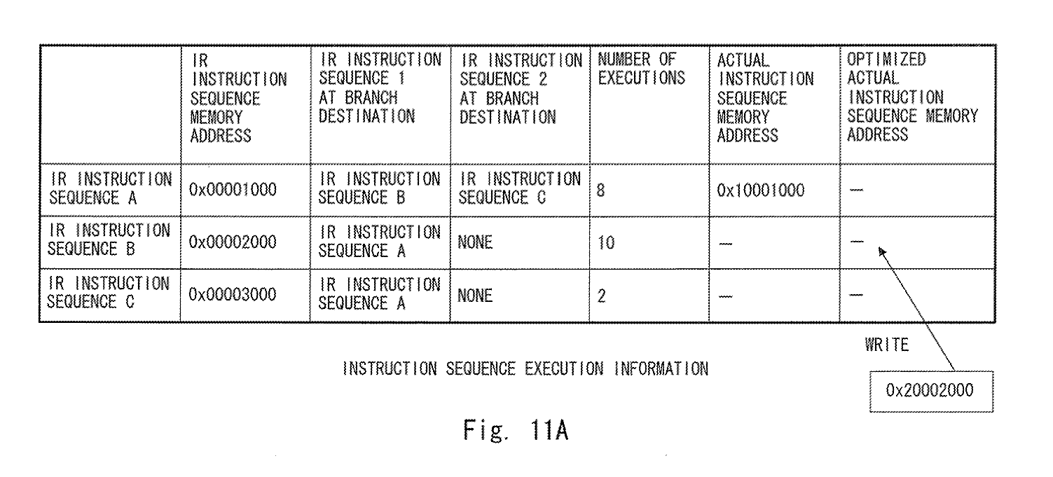

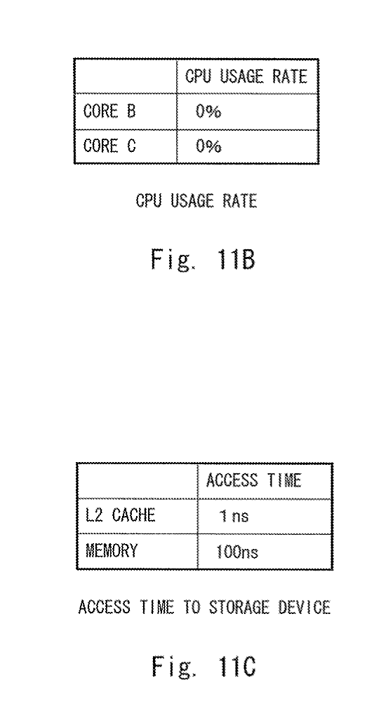

Next, a first example of the present invention is explained with reference to FIGS. 10 and 11. This example corresponds to the first exemplary embodiment of the present invention.

As shown in FIG. 10, this example is a JIT-compile system including a multi-core CPU 008 and a single-core CPU 009.

Note that as shown in FIG. 11A, instruction sequence execution information 323 contains memory addresses of IR instruction sequences 320, branch destination IR instruction sequence information of the IR instruction sequences 320, the numbers of executions of the IR instruction sequences 320, memory addresses of actual instruction sequences 321, and memory addresses of optimized actual instruction sequences 322. Further, FIG. 11B shows the CPU usage rates of CPU cores 020, 120 and 220. Further, FIG. 11C shows time necessary for the access from a core A corresponding to the primary arithmetic unit to an L2 cache 123 and a memory 223 corresponding to the shared storage devices 123 and 223 respectively.

Firstly, when JIT-compile means 021 is about to execute an IR instruction sequence A, instruction sequence selection means 022 determines whether or not there is any IR instruction sequence for which the optimization process has not been performed yet among the relevant IR instruction sequences of the IR instruction sequence A. By referring to the instruction sequence execution information 323, it is recognized that there are IR instruction sequences for which the optimization process has not been performed yet among the relevant IR instruction sequences. Therefore, the instruction sequence selection means 022 selects an IR instruction sequence B that has been executed more times than any other relevant IR instruction sequences as an IR instruction sequence to be optimized.

Next, arithmetic unit selection means 023 selects an arithmetic unit that actually executes the optimization process. For this process, assume that the arithmetic unit selection means 023 preferentially selects an arithmetic unit for which the calculation result of “αk+Tk” is lower, where αk (%) is a CPU usage rate of a kth arithmetic unit (1≦k≦n) and Tk (ns) is an access time to the shared storage device 123 or 223, which is shared with the core A corresponding to the primary arithmetic unit. In this example, the shared storage device that is shared between the core A 020 and the core B 120 is the L2 cache 123. Further, the shared storage device that is shared between the core A 020 and the core C 220 is the memory 223. Therefore, the calculation result for the core B 120 is 1 (=0+1) and the calculation result for the core C 220 is 100 (=0+100). As a result, the arithmetic unit selection means 023 selects the core B 120 as the core that executes the optimization process and thereby instructs the core B to optimize the IR instruction sequence B.

In accordance with this instruction, first optimization means 121 of the core B 120 carries out the optimization process of the IR instruction sequence B. Then, assuming that the memory address of the converted optimized actual instruction sequence 322 is 0x20002000, the first optimization means 121 writes that memory address into the instruction sequence execution information 323.

After these processes, when the JIT-compile means 021 of the core A 020 is about to execute the IR instruction sequence B, it executes the optimized actual instruction sequence B based on the instruction sequence execution information 323. Since the optimized actual instruction sequence B generated in this manner can be executed more quickly than the actual instruction sequence B generated by the JIT-compile means 021, the execution speed of the program that is executed by the JIT-compile system is improved.

### Second Example

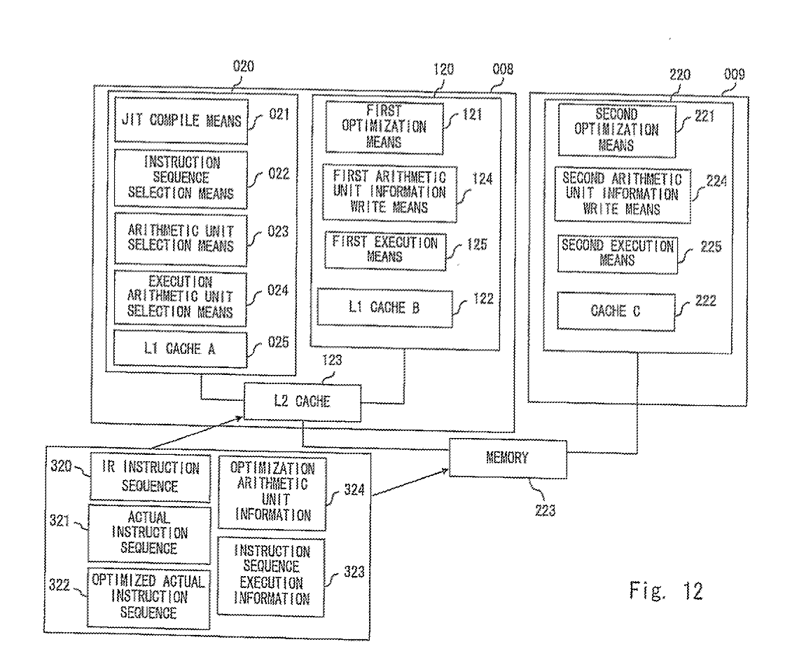

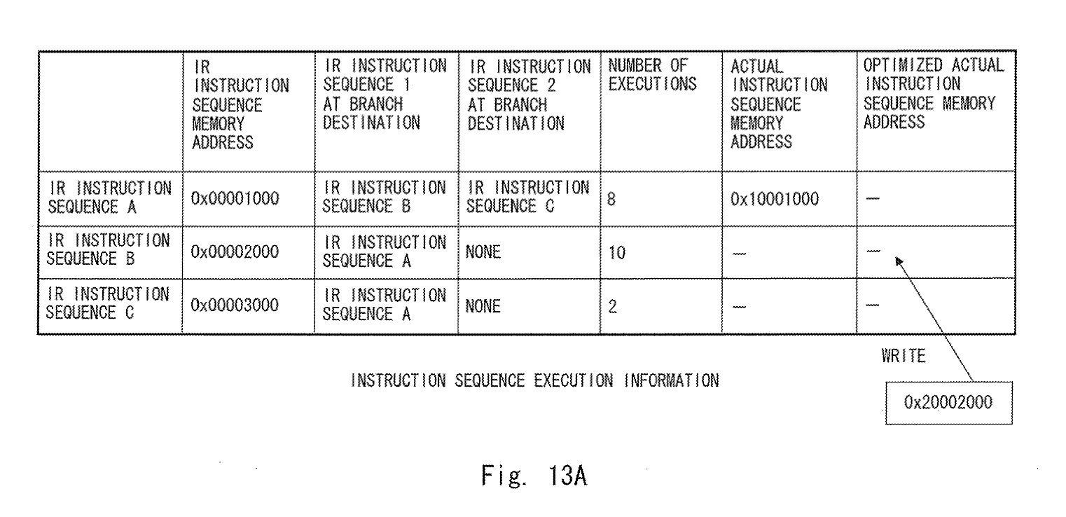

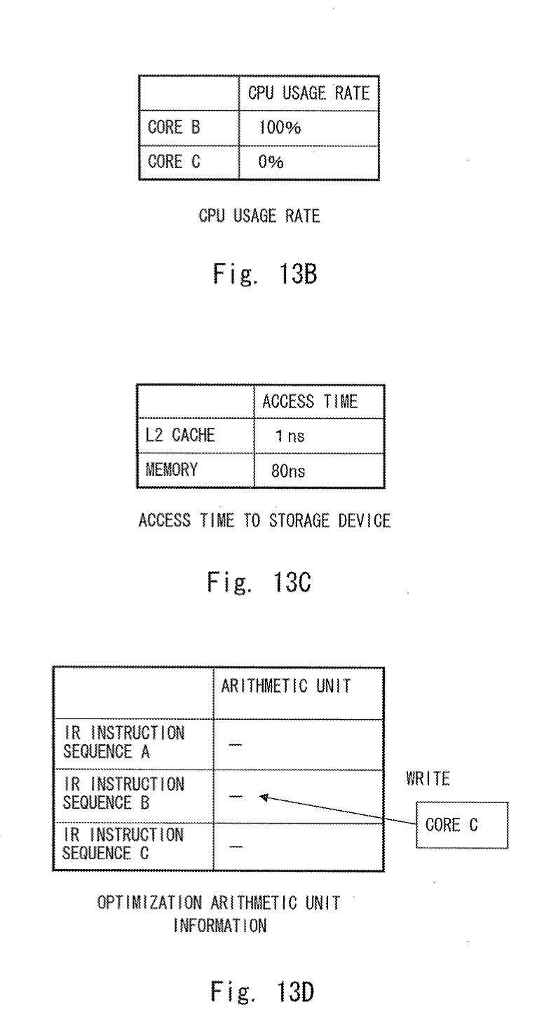

Next, a second example of the present invention is explained with reference to FIGS. 12 and 13. This example corresponds to the second exemplary embodiment of the present invention.

As shown in FIG. 12, this example is a JIT-compile system including a multi-core CPU 008 and a single-core CPU 009.

Note that as shown in FIG. 13A, instruction sequence execution information 323 contains memory addresses of JR instruction sequences 320, branch destination IR instruction sequence information of the IR instruction sequences 320, the numbers of executions of the IR instruction sequences 320, memory addresses of actual instruction sequences 321, and memory addresses of optimized actual instruction sequences 322. Further, FIG. 13B shows the CPU usage rates of CPU cores 020, 120 and 220. Further, FIG. 13C shows time necessary for the access from a core A corresponding to the primary arithmetic unit to each of the shared storage devices 123 and 223. Further, optimization arithmetic unit information 324 is stored as shown in FIG. 13D.

Firstly, when JIT-compile means 021 is about to execute an IR instruction sequence A, instruction sequence selection means 022 determines whether or not there is any IR instruction sequence for which the optimization process has not been performed yet among the relevant IR instruction sequences of the IR instruction sequence A. By referring to the instruction sequence execution information 323, it is recognized that there are IR instruction sequences for which the optimization process has not been performed yet among the relevant IR instruction sequences of the IR instruction sequence A. Therefore, the arithmetic unit selection means 023 selects an IR instruction sequence B that has been executed more times than any other relevant IR instruction sequences as an IR instruction sequence to be optimized.

Next, arithmetic unit selection means 023 selects an arithmetic unit that actually executes the optimization process. For this process, assume that the arithmetic unit selection means 023 preferentially selects an arithmetic unit for which the calculation result of “αk+Tk” is lower, where αk (%) is a CPU usage rate of a kth arithmetic unit (1≦k≦n) and Tk (ns) is an access time to the shared storage device 123 or 223, which is shared with the core A corresponding to the primary arithmetic unit. In this example, the shared storage device that is shared between the core A 020 and the core B 120 is the L2 cache 123. Further, the shared storage device that is shared between the core A 020 and the core C 220 is the memory 223. Therefore, the calculation result for the core B 121 is 101 (=100+1) and the calculation result for the core C 220 is 80 (=0+80). As a result, the arithmetic unit selection means 023 selects the core C 220 as the core that executes the optimization process and thereby instructs the core C 220 to optimize the IR instruction sequence B.

In accordance with this instruction, second optimization means 221 of the core C 220 performs the optimization of the IR instruction sequence B. Then, assuming that the memory address of the converted optimized actual instruction sequence is 0x20002000, the second optimization means 221 writes that memory address into the instruction sequence execution information 323. Further, second arithmetic unit information write means 224 writes the association between the IR instruction sequence B and its own arithmetic unit identifier “core C” into optimization arithmetic unit information 324.

After these processes, when the JIT-compile means 021 of the core A 020 is about to execute the IR instruction sequence B, execution arithmetic unit selection means 025 recognizes the core C 220 as the core that has optimized the optimized actual instruction sequence B by referring to the optimization arithmetic unit information 324 and instructs the core C 220 to execute the optimized actual instruction sequence B. Since second execution means 225 of the core C 220 can execute the optimized actual instruction sequence B, which is stored in its own cache C222, in accordance with this instruction, the execution speed of the program is improved in the JIT-compile system.

### Third Example

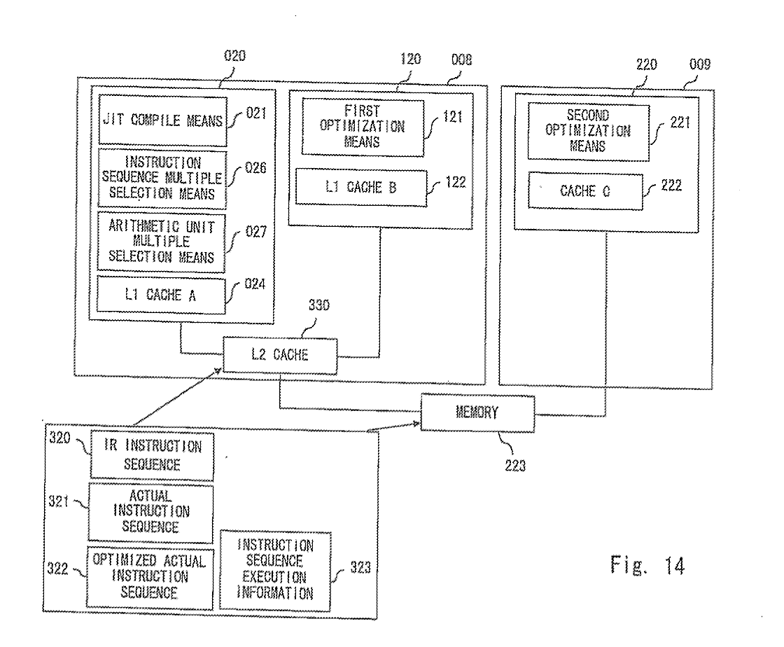

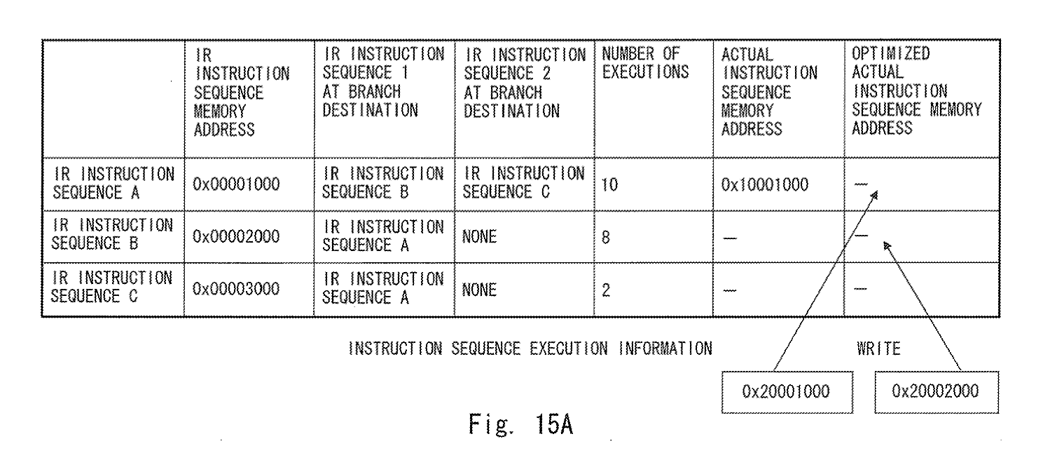

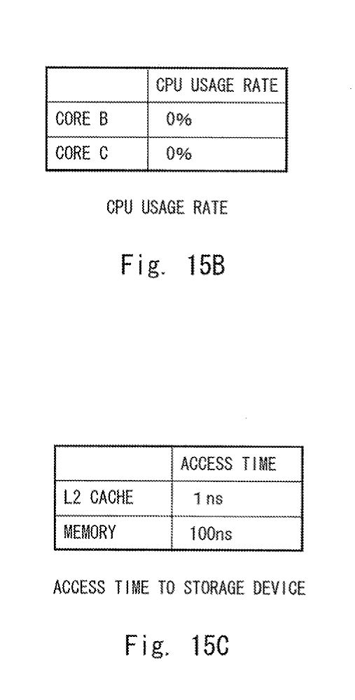

Next, a third example of the present invention is explained with reference to FIGS. 14 and 15. This example corresponds to the third exemplary embodiment of the present invention.

As shown in FIG. 14, this example is a JIT-compile system including a multi-core CPU 008 and a single-core CPU 009.

Note that as shown in FIG. 15A, instruction sequence execution information 323 contains memory addresses of IR instruction sequences 320, branch destination IR instruction sequence information of the IR instruction sequences 320, the numbers of executions of the IR instruction sequences 320, memory addresses of actual instruction sequences 321, and memory addresses of optimized actual instruction sequences 322. Further, FIG. 15B shows the CPU usage rates of CPU cores 020, 120 and 220. Further, FIG. 15C shows time necessary for the access from a core A corresponding to the primary arithmetic unit to each of the shared storage devices 123 and 223. Further, instruction sequence multiple selection means 026 selects two IR instruction sequences 320 that have been executed more times than the other IR instruction sequences.

Firstly, when JIT-compile means 021 is about to execute an IR instruction sequence A, instruction sequence multiple selection means 026 determines whether or not there is any IR instruction sequence for which the optimization process has not been performed yet among the relevant IR instruction sequences of the IR instruction sequence A. By referring to the instruction sequence execution information 323, it is recognized that there are IR instruction sequences for which the optimization process has not been performed yet among the relevant IR instruction sequences of the IR instruction sequence A. Therefore, the instruction sequence multiple selection means 026 selects the IR instruction sequence A itself and an IR instruction sequence B that have been executed more times than the other relevant IR instruction sequences as IR instruction sequences to be optimized.

Next, arithmetic unit multiple selection means 027 selects an arithmetic unit that actually executes the optimization process. For this process, assume that the arithmetic unit multiple selection means 027 preferentially selects an arithmetic unit for which the calculation result of “αk+Tk” is lower, where αk (%) is a CPU usage rate of a kth arithmetic unit (1≦k≦n) and Tk (ns) is an access time to the shared storage device 123 or 223, which is shared with the core A corresponding to the primary arithmetic unit. In this example, the shared storage device that is shared between the core A 020 and the core B 120 is the L2cache 123. Further, the shared storage device that is shared between the core A 020 and the core C 220 is the memory 223. Therefore, the calculation result for the core B 120 is 1 (=0+1) and the calculation result for the core C 220 is 100 (=0+100). As a result, the arithmetic unit multiple selection means 027 selects the core B 120 as the core that optimizes the IR instruction sequence A and selects core C 220 as the core that optimizes the IR instruction sequence B. Further, the arithmetic unit multiple selection means 027 instructs each of the selected cores to optimize a respective one of the IR instruction sequences.

In accordance with these instructions, the IR instruction sequence A is optimized in the core B 120. Assuming that the memory address of the converted optimized actual instruction sequence A is 0x20001000, that memory address is written into the instruction sequence execution information 323. At the same time, the IR instruction sequence B is optimized in the core C 220. Assuming that the memory address of the converted optimized actual instruction sequence B is 0x20002000, that memory address is written into the instruction sequence execution information 323.

After these processes, when the JIT-compile means 021 of the core A 020 is about to execute the IR instruction sequence A and the IR instruction sequence B at the branch destination of the IR instruction sequence A, the JIT-compile means 021 can execute the optimized actual instruction sequences A and B successively. As a result, the execution speed of the program that is executed by the JIT-compile system is improved.

The above-explained JIT-compile system according to the present invention can be configured by supplying a storage medium storing a program that is used to implement the functions of the above-described exemplary embodiments to a system or an apparatus and then by causing a computer, a CPU, or an MPU (Micro Processing Unit) of the system or the apparatus to execute this program.

Further, this program can be stored in various types of storage media, and/or can be transmitted through communication media. Note that examples of the storage media include a flexible disk, a hard disk, a magnetic disk, magneto-optic disk, a CD-ROM (Compact Disc Read Only Memory), a DVD (Digital Versatile Disc), a BD (Blu-ray Disc), a ROM (Read Only Memory) cartridge, a RAM (Random Access Memory) memory cartridge with a battery backup, a flash memory cartridge, and a nonvolatile RAM cartridge. Further, examples of the communication media include a wire communication medium such as a telephone line, a radio communication medium such as a microwave line, and the Internet.

Further, in addition to the embodiments in which the above-described functions of the above-described exemplary embodiments are implemented by causing a computer to execute a program that is used to implement the functions of the above-described exemplary embodiments, other embodiments in which the functions of the above-described exemplary embodiments are implemented in cooperation with the OS (Operating System) or application software running on the computer according to instructions of this program are also included in the exemplary embodiments of the present invention.

Furthermore, embodiments in which the functions of the above-described exemplary embodiments are implemented by performing at least part of the functions by using a function expansion board inserted into the computer and/or a function expansion unit connected to the computer are also included in the exemplary embodiments of the present invention.

This application is based upon and claims the benefit of priority from Japanese patent application No. 2009-073426, filed on Mar. 25, 2009, the disclosure of which is incorporated herein in its entirety by reference.

### REFERENCE SIGNS LIST

000 030 PRIMARY ARITHMETIC UNIT
001, 021, 031 JIT COMPILE MEANS
002, 022 INSTRUCTION SEQUENCE SELECTION MEANS
003, 023 ARITHMETIC UNIT SELECTION MEANS
004 PRIMARY LOCAL STORAGE DEVICE
005, 025 EXECUTION ARITHMETIC UNIT SELECTION MEANS
006, 026 INSTRUCTION SEQUENCE MULTIPLE SELECTION MEANS
007, 027 ARITHMETIC UNIT MULTIPLE SELECTION MEANS
020 CORE A
024 L1 CACHE A
031 INSTRUCTION SEQUENCE EXECUTION MEANS
032 OPTIMIZATION ARITHMETIC UNIT SELECTION MEANS
120 CORE B
124 L1 CACHE B
220 CORE C
224 L1 CACHE C
123 L2 CACHE
130, 230, N30 OPTIMIZATION ARITHMETIC UNIT
131, 231, N31 OPTIMIZATION MEANS
132, 232, N32 SHARED STORAGE DEVICE
100 FIRST ARITHMETIC UNIT
101, 121 FIRST OPTIMIZATION MEANS
102 FIRST LOCAL STORAGE DEVICE
103 FIRST SHARED STORAGE DEVICE
104, 124 FIRST ARITHMETIC UNIT INFORMATION WRITE MEANS
105, 125 FIRST EXECUTION MEANS
110, 320, 330 IR INSTRUCTION SEQUENCE
111, 321 ACTUAL INSTRUCTION SEQUENCE
112, 322 OPTIMIZED ACTUAL INSTRUCTION SEQUENCE
113, 323 INSTRUCTION SEQUENCE EXECUTION INFORMATION
114, 324 OPTIMIZATION ARITHMETIC UNIT INFORMATION
200 SECOND ARITHMETIC UNIT
201, 221 SECOND OPTIMIZATION MEANS
202 SECOND LOCAL STORAGE DEVICE
203 SECOND SHARED STORAGE DEVICE
204, 224 SECOND ARITHMETIC UNIT INFORMATION WRITE MEANS
205, 225 SECOND EXECUTION MEANS
223 MEMORY
331 OPTIMIZED ACTUAL INSTRUCTION SEQUENCE
n00 nTH ARITHMETIC UNIT
n01 nTH OPTIMIZATION MEANS
n02 nTH LOCAL STORAGE DEVICE
n03 nTH SHARED STORAGE DEVICE
n04 nTH ARITHMETIC UNIT INFORMATION WRITE MEANS
n05 nTH EXECUTION MEANS

1. A compile system comprising:
a primary arithmetic unit;
a plurality of optimization arithmetic units;
a plurality of shared storage devices, each the plurality of shared storage devices being able to be accessed from the primary arithmetic unit and being associated with one of the plurality of optimization arithmetic units, wherein
each of the optimization arithmetic units comprises an optimization unit generating an optimized actual instruction sequence from an IR instruction sequence and storing the generated optimized actual instruction sequence into a shared storage device corresponding to the optimization arithmetic unit itself, and
the primary arithmetic unit comprises:
an optimization arithmetic unit selection unit selecting an optimization arithmetic unit that generates the optimized actual instruction sequence based on an access time from the primary arithmetic unit to the shared storage devices; and
an instruction sequence execution unit executing the optimized actual instruction sequence stored in the shared storage devices.

2. The compile system according to claim 1, wherein the optimization arithmetic unit selection unit preferentially selects an optimization arithmetic unit corresponding to a shared storage device having a shorter access time.

3. The compile system according to claim 1, wherein the optimization arithmetic unit selection unit selects the optimization arithmetic unit based on a usage rate of the optimization arithmetic unit.

4. The compile system according to claim 1, wherein
the optimization unit further stores instruction sequence execution information associating the IR instruction sequence with an optimized actual instruction sequence generated from that IR instruction sequence into the shared storage device, and
when the instruction sequence execution unit determines that there is an optimized actual instruction sequence corresponding to the IR instruction sequence based on the instruction sequence execution information, the instruction sequence execution unit executes the optimized actual instruction sequence stored in the shared storage device.

5. The compile system according to claim 4, wherein when the instruction sequence execution unit determines that there is no optimized actual instruction sequence corresponding to the IR instruction sequence, the instruction sequence execution unit generates a non-optimized actual instruction sequence from the IR instruction sequence and executes the generated non-optimized actual instruction sequence.

6. The compile system according to claim 5, wherein
the instruction sequence execution unit further stores the generated non-optimized actual instruction sequence into a shared storage device and stores information associating the IR instruction sequence with the non-optimized actual instruction sequence generated from that IR instruction sequence into the instruction sequence execution information, and
when instruction sequence execution unit determines that there is no optimized actual instruction sequence corresponding to the IR instruction sequence and determines that there is a non-optimized actual instruction sequence corresponding to the IR instruction sequence based on the instruction sequence execution information, the instruction sequence execution unit executes the non-optimized actual instruction sequence stored in the shared storage device.

7. The compile system according to claim 4, wherein
the optimization arithmetic unit further comprises:
a local storage device into which the generated optimized actual instruction sequence is cached; and
an arithmetic unit information storing unit storing optimization arithmetic unit information associating the IR instruction sequence from which the optimized actual instruction sequence is generated with the optimization arithmetic unit itself into the shared storage device, and
the primary arithmetic unit further comprises an execution arithmetic unit selection unit, when the primary arithmetic unit determines that there is an optimized actual instruction sequence corresponding to the IR instruction sequence, executing the optimized actual instruction sequence by causing an optimization arithmetic unit determined based on the optimization arithmetic unit information to execute the optimized actual instruction sequence cached in the local storage device.

8. The compile system according to claim 1, wherein the primary arithmetic unit further comprises an instruction sequence selection unit selecting an IR instruction sequence from which the optimized actual instruction sequence is generated from among relevant IR instruction sequences that will be possibly executed in conjunction with an IR instruction sequence that is currently being executed by the primary arithmetic unit.

9. The compile system according to claim 8, wherein
the instruction sequence selection unit selects a plurality of IR instruction sequences from which optimized actual instruction sequences are generated, and
the optimization arithmetic unit selection unit selects the optimization arithmetic units in such a manner that each of the selected optimization arithmetic units corresponds to a respective one of the plurality of selected IR instruction sequences.

10. The compile system according to claim 8, wherein the instruction sequence selection unit selects an IR instruction sequence from which the optimized actual instruction sequence is generated based on a number of executions of the IR instruction sequence.

11. The compile system according to claim 1, wherein the plurality of shared storage devices forms a storage hierarchy.

12. The compile system according to claim 1, wherein
the arithmetic unit is a CPU core, and
the storage device is a memory.

13. A compile method comprising:
determining whether or not an optimized actual instruction sequence is to be generated from an IR instruction sequence; and
selecting, when the optimized actual instruction sequence is to be generated, an optimization arithmetic unit that generates the optimized actual instruction sequence from among a plurality of optimization arithmetic units based on an access time from a primary arithmetic unit to a plurality of shared storage devices, each of the plurality of shared storage devices being able to be accessed from the primary arithmetic unit and being associated with one of the plurality of optimization arithmetic units.

14. The compile method according to claim 13, wherein in the selection of an optimization arithmetic unit, an optimization arithmetic unit corresponding to a shared storage device having a shorter access time is preferentially selected.

15. The compile method according to claim 13, wherein in the selection of an optimization arithmetic unit, an optimization arithmetic unit is selected based on a usage rate of the optimization arithmetic unit.

16. The compile method according to claim 13, further comprising:
storing an optimized actual instruction sequence generated by the selected Optimization arithmetic unit into a shared storage device corresponding to the optimization arithmetic unit itself, and storing instruction sequence execution information associating the IR instruction sequence with the optimized actual instruction sequence generated from that IR instruction sequence, and
causing, when it is determined that there is an optimized actual instruction sequence corresponding to the IR instruction sequence based on the instruction sequence execution information, the primary arithmetic unit to execute the optimized actual instruction sequence stored in the shared storage device.

17. The compile method according to claim 16, wherein in the execution of the instruction sequence, when it is determined that there is no optimized actual instruction corresponding to the IR instruction sequence, a non-optimized actual instruction sequence is generated from the IR instruction sequence and the generated non-optimized actual instruction sequence is executed.

18. The compile method according to claim 17, wherein
the execution of the instruction sequence further comprises storing the generated non-optimized actual instruction sequence into a shared storage device and storing information associating the IR instruction sequence with the non-optimized actual instruction sequence of that IR instruction sequence into the instruction sequence execution information, and
when it is determined that there is no optimized actual instruction sequence corresponding to the IR instruction sequence and determined that there is a non-optimized actual instruction sequence corresponding to the IR instruction sequence based on the instruction sequence execution information, the non-optimized actual instruction sequence stored in the shared storage device is executed.

19. The compile method according to claim 16, further comprising:
causing the optimization arithmetic unit to cache the generated optimized actual instruction sequence;
storing optimization arithmetic unit information associating the IR instruction sequence from which the optimized actual instruction sequence is generated with an optimization arithmetic unit that has generated that optimized actual instruction sequence; and
executing, when it is determined that there is an optimized actual instruction sequence corresponding to the IR instruction sequence, the optimized actual instruction sequence by causing an optimization arithmetic unit determined based on the optimization arithmetic unit information to execute the optimized actual instruction sequence cached in that optimization arithmetic unit.

20. The compile method according to claim 13, further comprising selecting an IR instruction sequence from which the optimized actual instruction sequence is generated from among relevant IR instruction sequences that will be possibly executed in conjunction with an IR instruction sequence that is currently being executed by the primary arithmetic unit.

21. The compile method according to claim 20, wherein
in the selection of an IR instruction sequence, a plurality of IR instruction sequences, from which optimized actual instruction sequences are generated, are selected, and
in the selection of an optimization arithmetic unit, optimization arithmetic units are selected in such a manner that each of the selected optimization arithmetic units corresponds to a respective one of the plurality of selected IR instruction sequences.

22. The compile method according to claim 20, wherein in the selection of an IR instruction sequence, an IR instruction sequence from which the optimized actual instruction sequence is generated is selected based on a number of executions of the IR instruction sequence.

23. The compile method according to claim 13, wherein the plurality of shared storage devices forms a storage hierarchy.

24. The compile method according to claim 13, wherein
the arithmetic unit is a CPU core, and
the storage device is a memory.

25. A storage medium storing a compile program that causes computer to execute:
a process of determining whether or not an optimized actual instruction sequence is to be generated from an IR instruction sequence; and
a process of selecting, when the optimized actual instruction sequence is to be generated, an optimization arithmetic unit that generates the optimized actual instruction sequence from among a plurality of optimization arithmetic units based on an access time from a primary arithmetic unit to a plurality of shared storage devices, each of the plurality of shared storage devices being able to be accessed from the primary arithmetic unit and being associated with one of the plurality of optimization arithmetic units.

26. The storage medium storing a compile program according to claim 25, wherein in the process of selecting an optimization arithmetic unit, an optimization arithmetic unit corresponding to a shared storage device having a shorter access time is preferentially selected.

27. The storage medium storing a compile program according to claim 25, wherein in the process of selecting an optimization arithmetic unit, an optimization arithmetic unit is selected based on a usage rate of the optimization arithmetic unit.

28. The storage medium storing a compile program according to claim 25 further comprising:
a process of storing an optimized actual instruction sequence generated by the selected optimization arithmetic unit into a shared storage device corresponding to the optimization arithmetic unit itself, and storing instruction sequence execution information associating the IR instruction sequence with the optimized actual instruction sequence generated from that IR instruction sequence, and
a process of causing, when it is determined that there is an optimized actual instruction sequence corresponding to the IR instruction sequence based on the instruction sequence execution information, the primary arithmetic unit to execute the optimized actual instruction sequence stored in the shared storage device.

29. The storage medium storing a compile program according to claim 28, wherein in the process of executing the instruction sequence, when it is determined that there is no optimized actual instruction corresponding to the IR instruction sequence, a non-optimized actual instruction sequence is generated from the IR instruction sequence and the generated non-optimized actual instruction sequence is executed.

30. The storage medium storing a compile program according to claim 29, wherein
the process of executing the instruction sequence further comprises storing the generated non-optimized actual instruction sequence into a shared storage device and storing information associating the IR instruction sequence with the non-optimized actual instruction sequence of that IR instruction sequence into the instruction sequence execution information, and
when it is determined that there is no optimized actual instruction sequence corresponding to the IR instruction sequence and determined that there is a non-optimized actual instruction sequence corresponding to the IR instruction sequence based on the instruction sequence execution information, the non-optimized actual instruction sequence stored in the shared storage device is executed.

31. The storage medium storing a compile program according to claim 28, further comprising:
a process of causing the optimization arithmetic unit to cache the generated optimized actual instruction sequence;
a process of storing optimization arithmetic unit information associating the IR instruction sequence from which the optimized actual instruction sequence is generated with an optimization arithmetic unit that has generated that optimized actual instruction sequence: and
a process of, when it is determined that there is an optimized actual instruction sequence corresponding to the IR instruction sequence, executing the optimized actual instruction sequence by causing an optimization arithmetic unit determined based on the optimization arithmetic unit information to execute the optimized actual instruction sequence cached in that optimization arithmetic unit.

32. The storage medium storing a compile program according to claim 25, further comprising a process of selecting an IR instruction sequence from which the optimized actual instruction sequence is generated from among relevant IR instruction sequences that will be possibly executed in conjunction with an IR instruction sequence that is currently being executed by the primary arithmetic unit.

33. The storage medium storing a compile program according to claim 32, wherein
in the process of selecting an instruction sequence, a plurality of IR instruction sequences, from which optimized actual instruction sequences are generated, are selected, and
in the process of selecting an optimization arithmetic unit, optimization arithmetic units are selected in such a manner that each of the selected optimization arithmetic units corresponds to a respective one of the plurality of selected IR instruction sequences.

34. The storage medium storing a compile program according to claim 32, wherein in the process of selecting an instruction sequence, an IR instruction sequence, from which the optimized actual instruction sequence is generated, is selected based on a number of executions of the IR instruction sequence.

35. The storage medium storing a compile program according to claim 25, wherein the plurality of shared storage devices forms a storage hierarchy.

36. The storage medium storing a compile program according to claim 25, wherein
the arithmetic unit is a CPU core, and
the storage device is a memory.
